(19) United States
(12) Patent Application Publication
(10) Pub. No.: US 2025/0217681 A1
(43) Pub. Date: Jul. 3, 2025

(54) Inference Engine Method for Data Modeling

(71) Applicants: Dylan Blanchard, Glen Allen, VA (US); Freddie J. Bourland, II, Glen Allen, VA (US)

(72) Inventors: Dylan Blanchard, Glen Allen, VA (US); Freddie J. Bourland, II, Glen Allen, VA (US)

(21) Appl. No.: 18/401,434

(22) Filed: Dec. 30, 2023

(51) Int. Cl. G06N 5/046; G06N 7/01

(52) U.S. Cl. CPC G06N 5/046; G06N 7/01

(57) ABSTRACT

This document presents a system and method for drastically decreasing the time and effort to go from a trained model to one viable for use in production by This drastically decreases time and effort to go from a trained model to one viable for use in production. The result of these innovations is that model creation time is now largely bound by training time and not data prep and coding for publication. The system provides data-observation-based inspections that yield a probability distribution to use for pipeline search in model creation. The result is that model creation time is now largely bound by training time and not data prep and coding for publication.

### COPYRIGHT NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever.

### BACKGROUND

While there are many automodeling systems available, they fall into 2 categories: inspection-based systems and search-based systems. Inspection-based integrate domain expert knowledge to observe data in a sequence of steps and select a most-appropriate transformation/model to use at each step. Search-based systems set up a probability distribution to try a wide variety of transformations and models. Some systems furthermore combine these by doing an inspection-based system to preprocess the data before a search-based approach.

### BRIEF DESCRIPTION OF THE DRAWINGS

Certain illustrative embodiments illustrating organization and method of operation, together with objects and advantages may be best understood by reference to the detailed description that follows taken in conjunction with the accompanying drawings in which:

FIG. 1 is a view of initial model training consistent with certain embodiments of the present invention.

FIG. 2 is a view of coding and inference engine consistent with certain embodiments of the present invention.

FIG. 3 is a view of a flow diagram for the pipeline selection and optimization process consistent with certain embodiments of the present invention.

FIG. 4 is a view of a flow diagram for the pipeline probability distribution process consistent with certain embodiments of the present invention.

FIG. 5 is a view of a flow diagram for the training dataset model creation process consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although no necessarily directly, and not necessarily mechanically.

Reference throughout this document to “one embodiment”, “certain embodiments”, “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

Reference throughout this document to “Pipeline”, “Complete Pipeline”, or “Optimal Pipeline” or similar terms means that a pipeline is a sequence of zero or more transformer and/or models to apply to data. An Optimal pipeline is one that is decided, such as by a search process or optimization process, to be the best for intended use.

Reference throughout this document to a “Prior” refers to a probability distribution of pipelines, or equivalently, a pairing of one or more score-pipeline combinations. In a prior the scores for the probability distribution must sum to one and are all in the range between 0 (not included) and 1 (included). There must be at least one up to infinitely many such combinations.

Reference throughout this document to “structurally similar” means that a dataset X being structurally similar to dataset Y dictates that dataset X must contain all the same column names in the same order with all the same datatypes as dataset Y.

Reference throughout this document to a “raw dataset” refers to a data set without any transformers being applied.

Reference throughout this document to an “inspector” refers to a software module that takes as input a prior containing a single pipeline and a raw dataset and produces a prior containing one or more pipelines. This is equivalent to producing a prior containing one or more pipelines, and the same raw dataset that was input. This dataset can be used immediately as the input to more inspector(s).

In an embodiment, data preparation consists of extracting data elements received from a plurality of systems. Data elements that have been extracted from the data received from various systems is transformed into a format that is suitable for training a model. For most projects, this step can consume up to 80% of the invested time. In the innovative system described herein, the system uses a unique approach to perform an inspection-based approach that yields a probability distribution of potential pipelines that may be searched across with a training dataset to find an optimal pipeline to deploy as a production model.

In an embodiment, model training utilizes the extracted and transformed data elements to place the data in the appropriate form to permit the use in the creation of a training model. The data is then presented to a training program that utilizes the transformed data to create a finished model. This step is highly automated today using standard processes. The model is typically in the form of an executable object that may be used to score new records as needed.

Automodeling systems primarily fall into 2 categories: inspection-based systems and search-based systems. Inspection-based systems integrate domain expert knowledge to observe data in a sequence of steps and select a most-appropriate transformation/model to use at each step. Search-based systems set up a probability distribution to try a wide variety of transformations and models. Some systems furthermore combine these by doing an inspection-based system to preprocess the data before a search-based approach. Our approach is unique in that it performs an inspection-based approach that yield a probability distribution of potential pipelines that can be searched over.

The traditional modeling process involves the following
1. Data preparation: Data that has been extracted from various systems is transformed into a format that is suitable for training a model. For most projects, this step can consume up to 80% of the invested time.
2. Model training: Once the data is in an appropriate form, it is presented to a training program that creates a finished model. This step is highly automated today using standard processes. The model is typically in the form of an executable object that may be used to score new records as needed.
3. Model selection: (1) and (2) may be repeated over and over to try different models, different transformations, and different parameters to fine-tune both.
4. Model publication: The model produced by (3) is in the form of an executable object. Using the object requires the data to be in the same format as that used to originally train the system. This requires one of three things:
   a. Require identical formats for training and usage.
   b. Writing and maintaining separate programming code for part (1) to be used in training and usage.
   c. Writing and maintaining an adapter that converts the data for usage back into the format used for training.

All of the above options are less than ideal. Approach (a) is very restrictive to the user of the model. Approach (b) requires time-consuming writing and maintaining of additional code. Approach (c) does as well and slows down the usage for the user by requiring these adapters to run before modeling.

The innovative system provides automatic detection of the transformations and the ability to re-use the transformation in model publication. In addition, the system provides communication of the transformation mapping through a metadata file that is created during data preparation. The system also provides for a data-observation-based inspection that yield a probability distribution to use for a pipeline search.

In an embodiment, the innovative system automates each of the 4 steps described above and provides improvements for each option. The first step and the second step are automated as a collection of automated “inspections” of the input data. Each inspection provides a variety of potential transformations and models and a probability distribution that represents the confidence in each transformation and model. These inspections are referred to as “priors”, and the creation of the priors is automated utilizing techniques to assign probabilities to various potential changes to the pipeline. In a non-limiting example, domain specific information may be prioritized more highly such as recognizing zip codes, recognizing multiple values from a specific dataset representing the same information. The above process drastically reduces the time and effort around training new models for new problems and allow a pathway for data transformations that are domain-specific to be integrated into a traditional modeling or automodeling workflow.

In an embodiment, an inspection strategy may utilize a sequence of inspectors feeding into an evaluation metric to optimize the inspector output. The novel inspection strategy system takes as input a pipeline, which may be empty, a raw dataset, and a sequence of inspectors where the pipeline and raw dataset are transmitted to the selected sequence of inspectors. This is generally accomplished by first analyzing the input pipeline and applying the pipeline being analyzed to the input dataset, which yields an intermediate dataset. The intermediate dataset may be dynamically observed and a variety of changes to the pipeline are proposed in the form of a probability distribution. This observation may be performed utilizing one or more machine learning algorithms, techniques, and principles, utilizing domain expertise, dataset expertise, or a combination of both. The machine learning algorithms and techniques may include hyperparameter tuning, one-hot-encoding, missing value imputation, cross validation, dataset splitting, and auto-modeling. The changes to the pipeline may be additions, deletions, updates to individual steps, or a combination of any of these operations. The inspection strategy system produces, as output, a prior.

The result of chaining together a sequence of inspectors may be a single global raw dataset and a tree of pipelines with associated conditional probabilities, where each pipeline leads to one or more created pipeline-probability combinations. Multiplying the created conditional probabilities yields a single probability distribution of completed pipelines, which is saved as a prior. This prior, containing the single probability distribution of completed pipelines, is the output of the inspection strategy system.

The selection system initiates a search process that takes as input a raw testing dataset that is distinct from the initial training raw dataset input to the inspection strategy system, but structurally similar to that raw training dataset, and the prior produced as a result of the inspection strategy system process. The search process outputs a single pipeline through accepting the pipeline with the greatest probability from the inspection strategy system, performing a random search over the pipelines in the input prior, performing a weighted search over the pipelines in the input prior, or performing a weighted Bayesian search, utilizing the weighting of the probabilities in the input prior.

As a best practice, it is common to use a train/test or train/test/holdout split or cross-validation, passing a dataset designated as the training dataset to a training evaluation system and passing a dataset designated as a testing dataset to a test evaluation system. Potentially, holdout data may be saved to evaluate the optimal pipeline's performance in an unbiased manner.

The evaluation process results in a single pipeline which is able to perform model training and/or model inference on a new dataset that is structurally similar to the training dataset. Existing constraints, as previously described, are very restrictive to users of the models, particularly for use in single-record inference where data is often passed across program boundaries, frequently resulting in differently-formatted values.

In this embodiment, the inspection strategy operation always starts with an empty pipeline and the untransformed or raw incoming dataset. With this initial condition of an empty pipeline and an untransformed dataset incoming to the system, an inspector is called into operation and takes as input an existing pipeline and the incoming dataset. The mechanism by which one pipeline can impact a modification to another pipeline utilizes an inspector taking as input an existing pipeline and producing as output a prior of resulting pipelines, where each pipeline is an update to the input pipeline. The inspector may use the pipeline to transform the raw dataset, and the inspector may also consider steps already added to the pipeline in order to suggest updates. An update to a pipeline may consist of a modification to a step or transformer in the form of adding removing, reordering, or changing the parameters of the step or transformer, or any combination of these modifications. The system may call a series of inspectors as the dataset passes through a pipeline to perform a series of operations, based upon the type of inspector in operation, and outputs a prior at the termination of each inspector process as the system iterates through the series of inspectors.

Each prior created at the end of an inspector or process step represents the confidence level of any updates to the pipeline. A prior is a probability distribution of pipeline(s) and confidence scores in those pipelines that add up to “1”. A score closer to the optimum value of “1” indicates that the inspector was more confident that the pipeline associated with that probability score yields a more optimal result for the proper distribution of train, test, and holdout splits for the dataset. Any given prior may represent multiple pipelines operating on the incoming dataset to determine the most optimal set of inspectors and process steps for processing the dataset type input to the system.

The publication system takes as input a metadata file specifying each column that is essential to the model to be created, as well as some of the properties of the metadata. These properties may include the column's ordered position in the data set, the data type for the column, the name of the column for use in model training, the name of the column for use in a single-record inference, and the required pre-processing steps for the column. The input may include the trained model from the evaluation process step. The output of the publication system may be a process for retraining the model with new raw data and a process for performing inference, for example predicting outcomes or providing outcome probabilities, on new data in the form of individual records.

The publication system may include a library of common transformations for typing and preprocessing with variations on each for raw data and for inference data.

In an embodiment, one or more dataset files are input to the system. The dataset file is analyzed to determine the columns and rows present in the dataset and a metadata file is created by the system that contains a snapshot of the columns represented in the dataset along with the format of the fields containing within each column. The metadata file can be used to guide an inspection of each column and the fields within that column for each dataset file. An inference name is created for each column. The system may then reformat the columns in the dataset file by converting inference names to training names and populate any missing fields with null values. Extra fields are removed and the columns of the dataset file are re-ordered to match the created metadata file. Each column is normalized such that all field values in the column are consistent. In a non-limiting example, a column that contains string values in most rows will be converted to all string values with missing fields filled in with string values, normalizing the entire column to string values. The system will process all columns by filling in missing values and normalizing the column values to the inferred field value for the column. The data set target name, defined in the metadata file, is extracted and the predictors forming the data set that has been reordered to match the metadata file are split out. The features are re-ordered and the re-ordered file is transferred to the modeling pipeline for further processing.

The publication system applies the library of common transformations based upon the configuration of the metadata file. The result of applying the transforms for training data or inference data is that the data is in a format structurally similar to what the pipeline expects, such as the data used to originally generate the pipeline.

The problems described above for model publication are resolved by using a tuned set of transforms with different code for inference and for training but configured via a metadata file and transformation use probabilities determined by machine learning expertise gained during processing and configured in the pipeline definition for further processing of future received datasets. In the novel system the metadata file creates transformations to be used in dataset processing in the creation of a data model. The transformations to be used in the creation of the data model may be set and defined by human data analysts. The transformations from both the metadata file and the pipeline processing definition are applied automatically and result in the data being in an identical format for processing of the data set in both inferred and training formats after being applied.

The pipeline definition of transformations and probabilities for each type of transformation determines which standard, packaged, and custom transformations may be applied as the dataset enters the pipeline process for inference and/or training formats. The transformation probabilities are established, again, through a combination of human data expertise and machine learning techniques to determine which standard, packaged, and custom transformations will have the best probability of a creation of an optimal model for the received input dataset. Results, such as accuracy of data transformation, speed of transformation, or errors, for each transformation step are reported dynamically as feedback to the machine learning engine and the human data analysts. Both the machine learning engine and the human data analysts are updated as to the efficiency, quality, and/or problems for each transformation as each transformation completes the action for which it was called. Transformations that produce greater efficiency in data model creation may have the probability of the use of that transformation increased for future dataset processing, whereas transformations that prohibit or reduce efficiency in data model creation may be subject to a decrease in the probability of use or removed altogether. Future received datasets may then reuse efficient transformations and transformation probabilities or utilize the updated set of transformations and transformation probabilities in subsequent pipeline actions to creation and publication of a data model. The feedback as to transformations and transformation probabilities continues to be evaluated for use as newly received datasets are processed to continue to optimize and update both the transformations and transformation probabilities to be applied in the creation and publication of data models.

This system drastically decreases time and effort to go from a trained model to one viable for use in production. This allows the system to publish a model with almost no effort. The result of these innovations is that model creation time is now largely bound by training time and not data preparation and coding for publication. Additionally, the novel system allows for a clear boundary between domain and data expertise (the metadata file) and machine learning expertise (the pipeline definition).

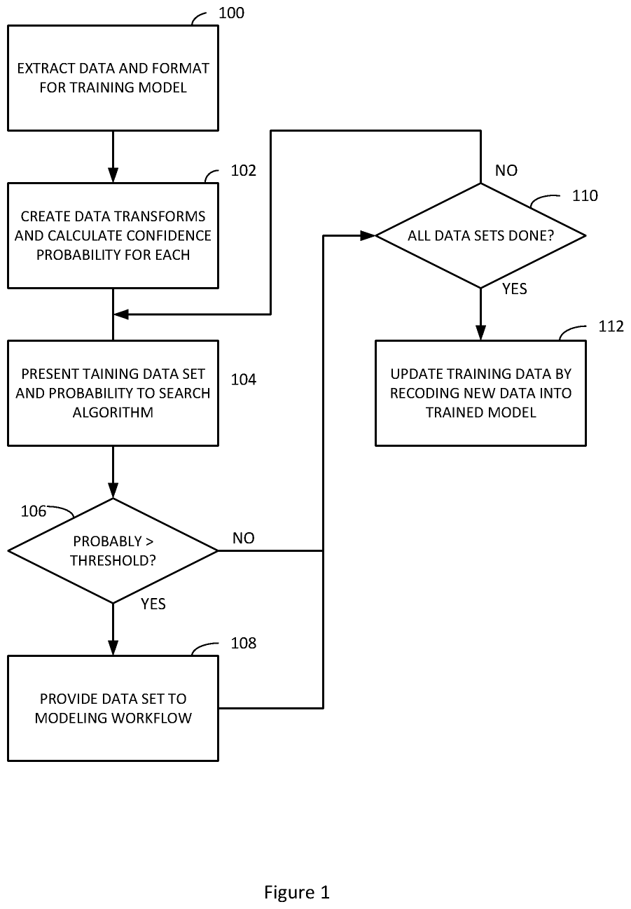

Turning now to FIG. 1, this figure presents a flow diagram for model training consistent with certain embodiments of the present invention. In an exemplary embodiment, at 100 the system extracts data from incoming datasets to format for training model datasets. The system creates data transformations based upon the final use for a production inference model and calculates the confidence probability for each transformation at 102. The training data set and probability for each training data set are presented to the machine learning search algorithm at 104. The system checks to determine if the probability for the training data set is above a minimum threshold level at 108. If a data set has been evaluated, at 110 a training data set that is above the minimum threshold level for probability is provided to the modeling workflow to expedite the search for the data sets to become production models. If there are additional data sets to be evaluated at 112, the system returns to step 106. If all data sets have been evaluated, at 114 the system updates training data by recording the new accepted data into a trained model.

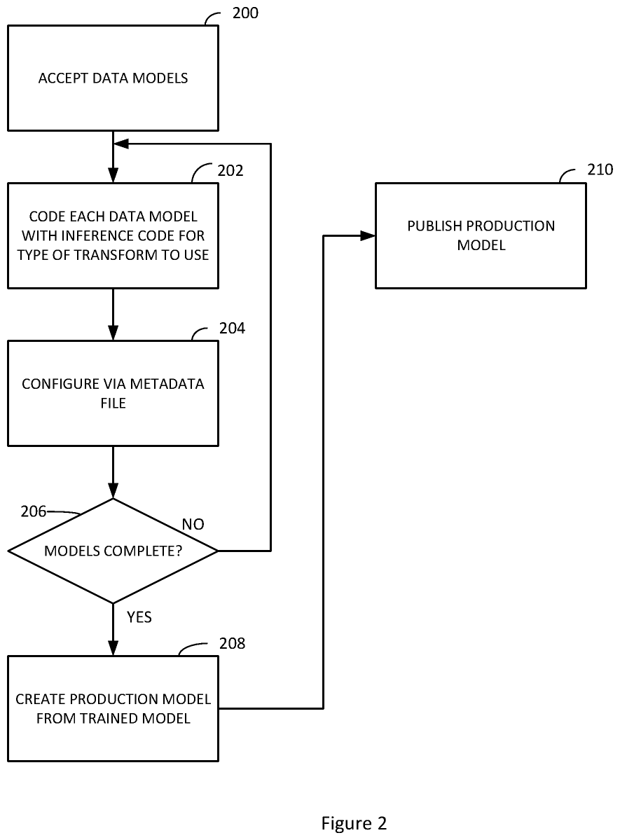

Turning now to FIG. 2, this figure presents a flow diagram for coding and the inference engine consistent with certain embodiments of the present invention. In an exemplary embodiment, at 200 the system accepts the data models that have met the minimum threshold for acceptance for data transformation. At 202 the system codes each data model with an inference code for the type of transform that will be used for the particular data set. At 204 the system will configure the model data through the use of a metadata file associated with the incoming data. The system checks, at 208, to determine if all data model sets have been evaluated. If there are additional data sets to be evaluated the system flow returns to step 202. If all data sets have been evaluated, at step 210 the system creates a production data model from the trained model data sets. At step 212 the created production data model is published for use in modeling workflow.

Turning now to FIG. 3, this figure presents a flow diagram for the pipeline selection and optimization process. At 300 a dataset is received by the system. At 302 the dataset inspector process analyzes the incoming data set and selects one or more pipeline processes and the probability of confidence for each of the selected pipeline processes and places this information into an output structure called a “prior” at 304. At 306 a splitter process creates train, test, and inferred splits of the dataset, where each split contains the input dataset, but where each split is used in a different analysis process step. At 308 the train dataset split is submitted to each pipeline process assigned in the prior in training mode which is monitored and operated by a machine learning algorithm. The machine learning algorithm monitors the results of the transformations that are processing elements of each pipeline and provides feedback to the system on the performance of the transformation in advancing to the goal of a data model generation output at 310. If the transformation used does not advance the processing of the dataset elements toward the goal at 312 the machine learning process updates the probabilities associated with the transformations, either decreasing or removing the particular transformation as not meeting the desired goal and the training analysis is reset and performed again with the new transformation probabilities in place.

If the transformations used in the pipeline do advance the processing of the dataset fields toward the goal of the data model generation the prior is updated with feedback as to the success of the set of transformations and assigned probabilities and the dataset advances to the test pipeline processes and evaluation probability generation at 314. Once again the dataset is processed through a set of transformations and their associated confidence probabilities in test mode at 316. If the prior does not produce optimum results in achieving the data model generation goal the transformations and confidence probabilities expressed in the prior are updated at 318 with feedback from the test dataset split. At 320 the system iterates on the test process dataset split utilizing the updated prior containing the recomputed transformations and confidence probabilities.

If the transformations in the prior utilized to process the test dataset split produce a positive result in reaching the goal of a data model generation the feedback from the test results is transmitted to the search process at 322. At 324 an inspection weighted Bayesian search is multiplied by the probabilities expressed in the prior to select the best pipeline for use in achieving the data model for the incoming data set. At 326 the selected pipeline is used to analyze the inferred dataset split and at 328 the data model for the input dataset is generated from the selected pipeline or set of pipelines as expressed in the created prior.

FIG. 4 is a view of a flow diagram for the pipeline probability distribution process consistent with certain embodiments of the present invention. At 400 an empty pipeline and an associated raw dataset are input to the pipeline probability distribution process. At 402 a semantic type inspector takes as input an existing pipeline and the associated raw dataset and outputs a prior, which represents confidence levels in the optimal update to the pipeline. An update to a pipeline may be an added step, a deleted step, a change to a step, or a combination of these update steps. At 404 the prior transmits each pipeline in a probability distribution of pipelines to a Missing Value inspector. At 406 the Missing Value inspector creates an updated pipeline probability based on the frequency of data elements in each of said pipelines in the pipeline probability distribution. At 408 each pipeline in the updated probability distribution is transmitted to a One Hot Encoder inspector. At 410 the pipeline probability distribution within the prior is modified to update each pipeline and associated dataset based upon the frequency of data elements in the associated dataset. At 412 each pipeline in the pipeline probability distribution with the prior is transmitted to the classification inspector. At 414 the system selects for output the pipeline and associated dataset having the highest probability of accuracy as a solution for creating the most representative data model for the input dataset.

FIG. 5 is a view of a flow diagram for the training dataset model creation process consistent with certain embodiments of the present invention. At 500 the training process receives a metadata file for inference processing. At 502 the training process reformats the columns of data withing the metadata file by converting inference names to training names and populating any missing fields to be populated with “null” values at 504. Any extra fields are removed and the columns are re-ordered to match the metadata file column structure at 506. At 508 a first column, Column A, is subjected to a “fill_w_other” preprocessor to fill missing values with the category “other” and converts column values to strings. At 510 a second column, Column B, is processed by a “to_bool” preprocessor applied to Column B to convert all values in the column to Boolean values. At 512, a third column, Column D, is processed by a preprocessor that applies data conversions and converts all values to integers in the column. At 514, a fourth column, Column E is processed by a True/False preprocessor that applies a True/False conversion for missing values. At the termination of the action by this preprocessor, all values in the column are represented as Boolean values. At 516, the target name is extracted and predictors are split out of the dataset. At 518 the system re-orders features to match the input metadata file and transmits the training metadata file to the modeling pipeline for review and evaluation.

While certain illustrative embodiments have been described, it is evident that many alternatives, modifications, permutations and variations will become apparent to those skilled in the art in light of the foregoing description.

We claim:

1. A system for optimizing data model creation, comprising:
a data processor receiving data for a data model creation;
said data processor inspecting the received data for type of data;
said data processor determining a data transform and a confidence probability for said determination;
said data processor creating a training data model utilizing the data sets according to said confidence probability;
said data processor publishing the training data model as a production data model.

2. The system of claim 1, where the inspecting is performed by a machine learning algorithm.

3. The system of claim 1, where confidence probability is measured through the evaluation of the metadata associated with a received data set.

4. The system of claim 1, where the received data sets are processed through a search of the data to determine the transformations a model data set with the highest probability of confidence.

5. The system of claim 1, where the data can be received, coded, and transformed for use in a training model data set in real time.

6. The system of claim 1, where the confidence probability is scored against a threshold value.

7. The system of claim 6, where the data sets with a confidence probability above said threshold value are prioritized for earlier transformation.

8. The system of claim 1, where the training data model is updated with all accepted data models prior to publication.

9. The system of claim 2, where the machine learning algorithm performs data-observation-based inspections that yield a probability distribution to use for a pipeline search.

10. The system of claim 9, where the machine learning algorithm re-uses the data transformations in the publication of a data model.
